(19) United States
(12) Patent Application Publication
(10) Pub. No.: US 2019/0030603 A1
(43) Pub. Date: Jan. 31, 2019

(54) DEVICE FOR AN APPARATUS FOR ADDITIVE PRODUCTION OF A COMPONENT

(71) Applicant: Siemens Aktiengesellschaft, Munich (DE)

(72) Inventor: Michael Ott, Mülheim an der Ruhr (DE)

(73) Assignee: Siemens Aktiengesellschaft, Munich (DE)

(21) Appl. No.: 16/072,535

(22) PCT Filed: Feb. 7, 2017
(86) PCT No.: PCT/EP2017/052602

§ 371 Date: Jul. 25, 2018

(30) Foreign Application Priority Data
Feb. 8, 2016 (DE) 10 2016 201 836.1

(51) Int. Cl. B22F 3/105

(52) U.S. Cl. CPC B22F 3/1055; B29C 64/255

(57) ABSTRACT

A device for an apparatus for additive production of a component from a powder bed has a wall for retaining a starting material for the additive production of the component, wherein the wall is designed to be heat-resistant at a temperature of at least 600° C. A method for additive production of the component in the apparatus includes the preheating of the starting material for the component to a temperature of at least 600° C.

### CROSS REFERENCE TO RELATED APPLICATIONS

This application is the US National Stage of International Application No. PCT/EP2017/052602 filed Feb. 7, 2017, and claims the benefit thereof. The International Application claims the benefit of German Application No. DE 102016201836.1 filed Feb. 8, 2016. All of the applications are incorporated by reference herein in their entirety.

### FIELD OF INVENTION

The present invention relates to a device for a plant for the additive production of a component, and also to a corresponding plant. A method for operating the plant is also the subject matter of the present invention, as well as a component which is produced according to the method.

In the case of the component, it is in particular an additively or generatively produced or built up component. It can especially be a workpiece or a component of a turbine, such as a steam turbine, in particular a gas turbine.

### BACKGROUND OF INVENTION

Known layered or additive production methods are especially selective laser melting (SLM), selective laser sintering (SLS) and electron beam melting (EBM). These methods are used especially in the production of three-dimensional objects by means of iterative stacking or joining together of layers, layered or volumetric elements, for example from a powder bed, on a build platform. Typical layer thicknesses of the individual layers lie between 20 μm and 60 μm.

A selective laser melting method is known from EP 1 355 760 B1 for example.

Such a method, as well electron beam melting, are especially suitable for processing or building up high-melting materials. In this case, there is the difficulty of building up the corresponding components with an expediently low degree of residual stresses. Residual stresses in the component can be reduced for example by preheating the especially powder-form raw material for the component, for example to a temperature of at least 500° C. The preheating or prewarming temperature, that is to say the temperature at which the component is heated or maintained before and/or during the additive build up, has to expediently lie below the melting point of the raw material.

The electron beam melting method is also known in the prior art. In this case, it is a generative method in which consecutive powder layers are deposited and selectively remelted using an electron beam. To this end, electrons, by applying a voltage in the region of 150 kV, are accelerated to approximately 60% of light speed, which during impingement upon the powder layer lead to the local remelting of the corresponding powder particles. In order to prevent the effect of the powder particles of the powder layer not being removed themselves from the powder bed during the impingement of the electrons, at least the regions to be remelted of each deposited powder layer can be pre-sintered before the remelting.

In any case, by means of the SLM method it has already been possible for an at least low-crack or low-stress production of components from a γ′ hardened, nickel-based superalloy to be demonstrated. This very hot cracking-susceptible material, however, had to be preheated via the build platform to a temperature of at least 500° C. in order to keep residual stresses of the component at an acceptable level (see above). In comparison to the component which is being produced, the powder bed is a very poor heat conductor. The heating of the powder via the build platform is therefore made increasingly difficult during the progressing production of the component since the powder particles of the respectively new layers of the powder bed are removed ever further from the build platform. Therefore, the (homogenous) tempering or preheating of the component is also a problem. A further difficulty exists in the thermal loading of a wall or of a housing for the powder bed or for the build platform which is arranged beneath the powder bed.

Conventional SLM plants offer for example the possibility of heating the build platform via a resistance heater. Such systems, however, allow only temperatures of the powder bed of up to approximately 500° C., for higher temperatures of the raw material recourse has to be made to other heat sources.

According to DE 10 2012 206 122 A1 it is proposed that preheating can also be achieved by means of an induction coil so that the component is inductively heated. The introduction of heat by means of induction is dependent on the geometry of the component, however. Uniform heating of the component can therefore be achieved only in the case of comparatively simple component geometries and compact types of construction of the component. In the case of more complex geometries, the forming of vortex flows in the component being produced is disturbed which is why a heterogeneous heating of the component occurs. Moreover, the cooling rate in the component is significant if specific structure states are to be achieved. For example, in the case of turbine components consisting of nickel-based or cobalt-based superalloys it is important for the forming of high-temperature strength that there is a high proportion of γ′ precipitates in the structure. These are formed, however, only if the component is cooled down below the γ′-solidus temperature of approximately 1150° C. slower than about 1° C./s. When producing components from a nickel-based superalloy it is therefore desirable to limit cooling of the component in the proximity of the melt bath to a corresponding temperature, or to heat the raw material to the highest possible temperatures before or during the additive production. To this end, the plant components which surround the powder bed and/or the raw material naturally also have to be correspondingly designed. This in particular makes high demands on the materials which are used.

### SUMMARY OF INVENTION

It is therefore an object of the present invention to specify means with which an additive production process for components to be produced from superalloys can be improved. In particular, improved heating of a raw material for a component to be additively produced, especially before or during the additive production, is to be achieved so that the structure properties of the finished component, especially with regard to γ′ precipitates in the material of the component, are improved.

This object is achieved by means of the subject matter of the independent patent claims. Advantageous embodiments are the subject matter of the dependent claims.

One aspect of the present invention relates to a device for a plant for the additive production of a component from a powder bed, comprising a wall for retaining or holding in an especially powder-form raw material for the additive production of the component, i.e. before or during the additive production.

The referenced powder bed is advantageously formed from the raw material.

In one embodiment, the device constitutes the wall.

The expression “retaining” or “holding in” is to be understood in such way that for the additive production the wall is advantageously in direct contact with the raw material. Correspondingly, during an expedient preheating of the raw material and/or during the additive production the wall is for example inevitably heated by the raw material or the powder bed to the currently referenced temperatures.

In the case of the wall, it can be a wall structure, an enclosure or a housing. The wall advantageously serves as a delimitation of the powder bed, for example in a corresponding plant for the additive production of the component. The wall advantageously delimits the raw material of the powder bed directly.

A further aspect of the present invention relates to a plant comprising the device, wherein the plant is designed to additively build up or produce a component of the described type from a superalloy, for example from a nickel-based or cobalt-base superalloy.

In one embodiment, the wall, at a temperature, for example a preheating temperature, of or for the raw material of at least 500° C., is designed to be heat resistant and/or to withstand the referenced temperature.

In one embodiment, the wall, at a temperature, for example a preheating temperature, of at least 600° C. is designed to be heat resistant or to withstand the referenced temperature.

In one embodiment, the wall, at a temperature, for example a preheating temperature, of at least 700° C. is designed to be heat resistant or to withstand the referenced temperature.

In one embodiment, the wall, at a temperature, for example a preheating temperature, of at least 800° C. is designed to be heat resistant or to withstand the referenced temperature.

In one embodiment, the wall, at a temperature, for example a preheating temperature, of at least 900° C. is designed to be heat resistant or to withstand the referenced temperature.

In one embodiment, the wall, at a temperature, for example a preheating temperature, of at least 1000° C. is designed to be heat resistant or to withstand the referenced temperature.

In one embodiment, the wall, at a temperature, for example a preheating temperature, of at least 1100° C., advantageously 1200° C. or more, is designed to be heat resistant or to withstand the referenced temperature.

In one embodiment, the wall is designed to retain, as raw material, a material for the additive production of the component from a precipitation hardened, or precipitation hardenable, superalloy. The referenced precipitation hardening advantageously relates to a γ or γ′ hardening or to the corresponding precipitates in the finished component.

The wall has a base material.

In one embodiment, the wall has a heat resistant, advantageously high-heat resistant, base material. The base material can be for example high-heat resistant steel and/or a superalloy, for example a nickel-based or cobalt-based superalloy. As a result of this embodiment, the wall, which for the additive production is expediently in direct contact with the raw material, can withstand those temperature to which the raw material is advantageously heated for the additive production or for an upstream preheating.

In one embodiment, the wall on an inner side of the base material has an anti-oxidation coating, for example an allite coating or diffusion coating.

The inner side in particular refers to a side of the base material which faces, especially directly faces, the raw material or the powder bed or is in (direct) contact therewith. As a result of this embodiment, an oxidation related or temperature related deterioration of the material structure of the base material can be advantageously prevented.

Correspondingly, an outer side of the base material in particular refers to a side of the base material which faces away from the raw material or the powder bed (for the production) and is advantageously not in contact with the raw material.

The base material has a thermal barrier coating on the inner side.

In one embodiment, the anti-oxidation layer is arranged between the thermal barrier coating and the base material. In this way, the base material can be particularly advantageously protected against the temperatures to which the raw material has to be heated for production of the component.

In one embodiment, the base material has a cooling structure on an outer side. As a result of this embodiment, the base material, whether it is already protected or not on its inner side by means of a thermal barrier coating and/or anti-oxidation coating, can be suitably cooled from the outside.

In one embodiment, the cooling structure, for cooling the wall and/or the base material of this, is designed to be exposed to a throughflow or inflow of a cooling fluid, for example air, water or nitrogen. This embodiment enables a particularly practical way of cooling.

In one embodiment, the wall forms a vertical boundary or housing for the raw material. A wall for a plant for the additive production can be meant by vertical boundary. The wall according to this embodiment can also define a production space for the component.

In one embodiment, the wall forms at least a part of a build platform for the additive production of the component. As a result of this embodiment, a component platform which offers the advantages according to the invention can be provided in a particularly practical manner.

In one embodiment, the device comprises a heat source which is designed to heat the raw material to a temperature of at least 500° for the additive production of the component.

In one embodiment, the heat source comprises an infrared lamp, a laser, especially one or more infrared lasers, and/or an inductive heating system. These are particularly practical embodiments in order to heat the raw material to suitably high temperatures, especially to temperatures of at least 500° C., before or during the additive production of the component.

A further aspect of the present invention relates to a method for operating the plant comprises the preheating of the raw material for the component (to be additively produced) to a temperature of at least 500° C.

A further aspect of the present invention relates to a component consisting of a superalloy, or comprising this, which is produced, or can be produced, by means of the described method.

The described method and/or described component also achieves the inventive objects as described above.

Embodiments, features and/or advantages which currently relate to the device and/or to the plant can also relate to the method and/or to the component, and vice versa.

### BRIEF DESCRIPTION OF THE DRAWINGS

Further details of the invention are described below with reference to the drawing.

FIG. 1 shows parts of schematic sectional or side view of a device for a plant for the additive production of a component.

FIG. 2 shows a schematic sectional or side view of the plant comprising the device.

### DETAILED DESCRIPTION OF INVENTION

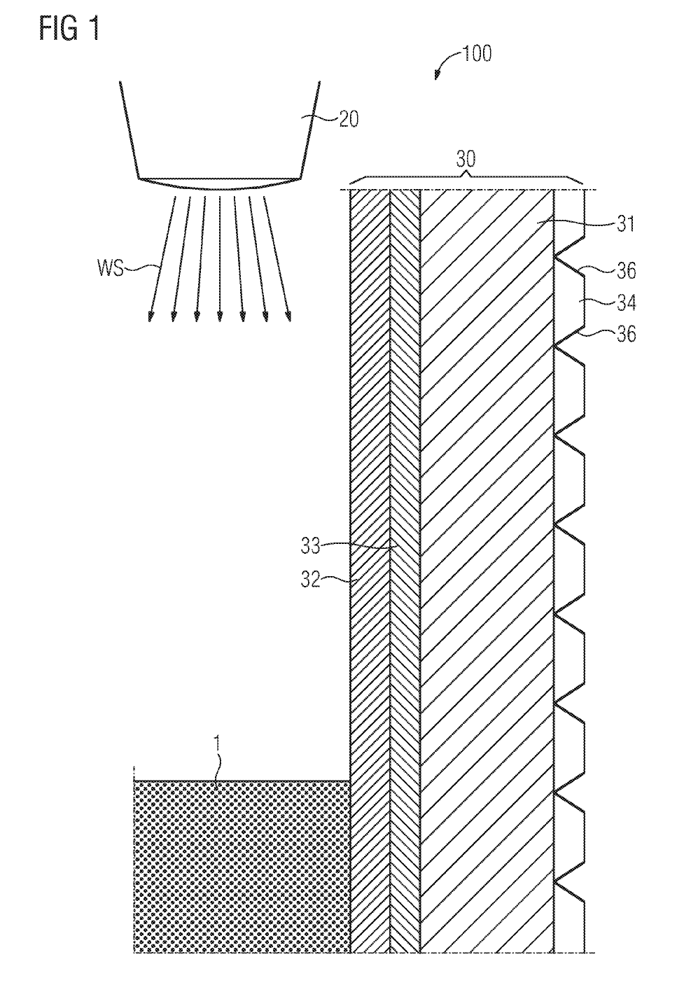

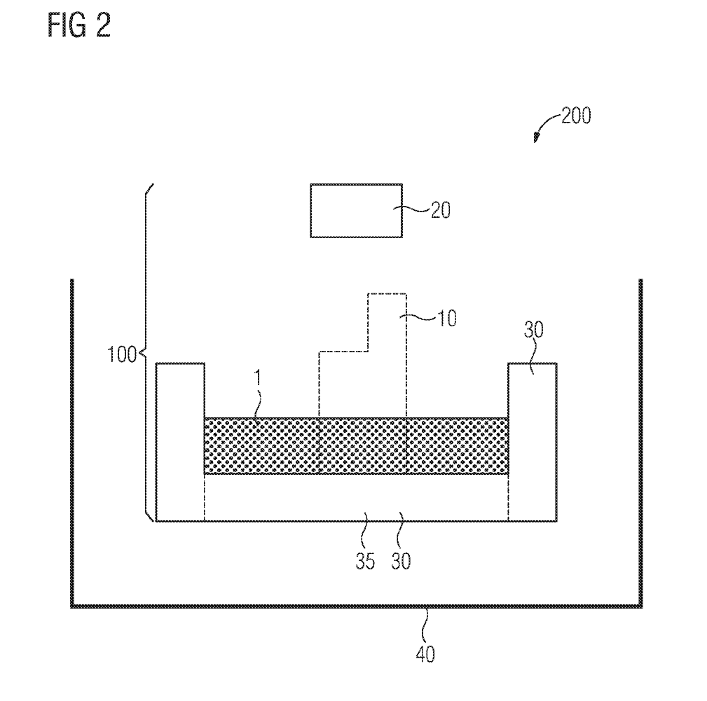

FIG. 1 shows a device 100. The device 100 is advantageously a device for a plant 200 for the additive production of a component 10 (see FIG. 2), especially from a powder bed.

The component 10 is advantageously to be produced from a superalloy, for example from a particularly precipitation hardened or γ-hardened nickel-based or cobalt-based superalloy. Such a superalloy can for example be the material “IN 625” or “Hastelloy X”.

The device 100 can form a powder boundary or housing for a raw material 1 for the component 10.

Also shown in FIG. 1 is advantageously the powder-form raw material 1 by which a powder bed is to be understood, which powder bed is delimited or retained by means of the wall 30, advantageously before or during an operation of the device 100, in the course of an additive production of the component.

The device 100 comprises a wall 30. The wall 30 is advantageously of heat-resistant design, advantageously high-heat resistant and/or high-temperature resistant design.

The wall 30 is advantageously designed to withstand a preheating temperature and/or operating temperature of the raw material 1 of at least 500° C. or more. The wall 30 is advantageously heat resistant at a temperature of at least 600°, especially 700° C., especially advantageously 800°, for example 1000° C. or more.

The wall 30, at even higher temperatures, for example a preheating temperature and/or operating temperature of the raw material 1 of 1200° or more, for example 1500° C. or even 2000° C. or 3000° C., can be designed to be heat resistant or to withstand these temperatures.

The wall 30 comprises a base material 31. On an inner side of the wall 31 (left hand side in FIG. 1), i.e. on a side of the base material 31 facing the raw material 1, the base material 1 comprises an anti-oxidation coating 33, especially for the protection of the base material 31 against oxidative or other thermally induced harmful influences. The anti-oxidation coating 33 can comprise a diffusion protection coating or for example chromium or a MCrAlY alloy.

The wall 30, on the inner side of this, furthermore comprises a thermal barrier coating 32. For the additive production of the component 10, the thermal barrier coating 32 is advantageously directly in contact with the raw material 1 or delimits this. The anti-oxidation coating 33 is expediently arranged between the base material 31 and the thermal barrier coating 32. As a result of this arrangement, the base material 31 of the wall 30 can be expediently protected against high thermal loads in the course of the additive production.

The wall 30 also has a cooling structure 34. The cooling structure is arranged on a side of the base material 31 (right hand side in FIG. 1) facing away from the raw material or the powder bed. The cooling structure 34 is provided in order to cool the base material 31 and/or the wall 30 from the outside. For this, the cooling structure 34 can simply be provided with a cooling surface or a structured cooling surface in order to enable a cooling effect or an improved heat exchange in comparison to a flat surface. Alternatively or additionally, the cooling structure 34 can have cooling channels 36 which can be closed or open in order for the cooling structure 34 to be exposed to a throughflow of a cooling fluid and to be actively cooled by it. The cooling fluid can comprise for example air, water, nitrogen or another fluid. The cooling structure 34 can also have a grid structure (not explicitly shown) for achieving a cooling effect.

The device 100 furthermore has a heat source 20 which is advantageously designed to heat the raw material 1 retained by the wall 30 to a temperature of at least 500° C. The heating can be both a preheating and a process heating, during the additive production. The heat source 20 expediently is, or comprises, an infrared lamp, a laser, such as an infrared laser, or a multiple laser arrangement and/or an inductive heating system. Resistance heaters are not suitable for heating the entire powder chamber to the referenced temperatures.

Within the scope of the present invention it is intended to heat the component 10 which is to be additively produced before the additive production of this and/or during it to a temperature of at least 500° in order to utilize the inventive advantages.

FIG. 2 schematically shows a sectional or side view of a plant 200 for the additive production of the component 10. The plant 200 is advantageously designed to additively build up or produce the component 10 from a powder bed.

The plant is advantageously a plant for the powder bed-based additive production of the component 10, especially for selective laser sintering or for electron beam melting.

The plant 200 comprises the device 100 described above. It can especially be seen in FIG. 2 that the device 100 has a multiplicity of walls 30 (as described above). Shown in the figure are for example two vertical walls 30 (sidewalls) which delimit the raw material 1 or the powder bed at the sides in order to retain or to contain the raw material 1. It is also to be seen that a build platform 35 is formed by a wall 30, as described above. The depicted embodiment has the advantage that the raw material 1, which is advantageously heated to particularly high temperatures for the additive production of the component 10, is retained on each side by a wall 30, which is correspondingly temperature resistant.

The device 100 can be a container for the raw material 1. The device 100 is in this case advantageously in direct contact with the raw material 1.

The plant 200 furthermore comprises one or more further plant parts, such as a coating device or a solidifying device; these are simply indicated by the designation 40.

By the description based on the exemplary embodiments, the invention is not limited to these but covers each new feature and each combination of features. This especially contains each combination of features in the patent claims, even if this feature or this combination itself is not explicitly disclosed in the patent claims or exemplary embodiments.

1.-13. (canceled)

14. A device for a plant for the additive production of a component from a powder bed, comprising:
a wall for retaining a raw material for the additive production of the component,
wherein the wall has a heat resistant base material and, on an inner side of the base material, a thermal barrier coating and an anti-oxidation coating,
wherein the wall is designed to be heat resistant at a temperature of at least 600° C.

15. The device as claimed in claim 14,
wherein the wall is designed to retain, as raw material, a material for the additive production of the component from a precipitation hardened, or precipitation hardenable, superalloy.

16. The device as claimed in claim 14,
wherein the base material has high-heat resistant steel and/or a superalloy.

17. The device as claimed in claim 14,
wherein the wall has a base material and, on an outer side of the base material, a cooling structure.

18. The device as claimed in claim 17,
wherein the cooling structure, for cooling the wall for the additive production, is designed to be exposed to a throughflow or inflow of a cooling fluid, air, water, or nitrogen.

19. The device as claimed in claim 14,
wherein the wall forms a vertical boundary for the raw material.

20. The device as claimed in claim 14,
wherein the wall forms at least one part of a build platform for the additive production of the component.

21. The device as claimed in claim 14, further comprising:
a heat source which is designed to heat the raw material to a temperature of at least 600° C. for the additive production of the component.

22. The device as claimed in claim 21,
wherein the heat source comprises an infrared lamp, a laser and/or an inductive heating system.

23. A plant, comprising:
a device as claimed in claim 14, which is designed to additively produce components from a superalloy, a nickel-based superalloy, or cobalt-based superalloy.

24. A method for operating a plant as claimed in claim 23, comprising:
preheating of a raw material for the component to a temperature of at least 600° C., and
additively producing a component from a powder bed.

25. A component, consisting of:
a superalloy which is produced by the method as claimed in claim 24.
